(19) United States
(12) Patent Application Publication
(10) Pub. No.: US 2014/0033188 A1
(43) Pub. Date: Jan. 30, 2014

(54) SYSTEM UPDATES FROM CLOUD BLOB STORAGE USING VHD DIFFERENTIALS

(71) Applicants: Jay Curtis Beavers, Duvall, WA (US); Nicholas Anthony Gunn, Redmond, WA (US)

(72) Inventors: Jay Curtis Beavers, Duvall, WA (US); Nicholas Anthony Gunn, Redmond, WA (US)

(73) Assignee: MICROSOFT CORPORATION, Redmond, WA (US)

(21) Appl. No.: 13/559,540

(22) Filed: Jul. 26, 2012

(51) Int. Cl. G06F 9/44

(52) U.S. Cl. 717/170

(57) ABSTRACT

A “Zero-Touch Manager” (“ZTM”) supplies updates to device firmware, operating system (OS), frameworks, applications, etc., from cloud-based or other network-accessible storage. These updates ensure that groups of “identical” devices (i.e., devices having the same hardware version) run from the same known state, while maintaining local customizations for individual devices. The ZTM uses sector-level differences to generate differential update versions (“diffs”) of Virtual Hard Disk (VHD) images of planned update versions relative to local hard drive images of each device's current version. Consequently, updates to the local hard drive image are achieved by replacing sectors of the local hard drive image that have corresponding changed sectors in the diff, though additional information may also be included in the diff. “Manifest” files are used in combination with the diffs to control device updates based upon the current version of the local hard drive image relative to update versions in the diff.

### BACKGROUND

Traditionally, operating systems (OS) change state by invoking an update service that runs applications to install changed portions of the OS or other applications or by downloading, installing, and locally configuring a new or updated version of the OS. Changing the state of the OS may include applying updates or reverting to a previous system state. Invoking an update service is less desirable due to the high rate of failure associated with update services, little control of the update, and the nondeterministic nature of the update relative to particular device configurations.

For example, if a failure occurs during an update, it may halt the OS, leaving it in a state where it may be impossible to move forward or roll back. In other words, failures occurring during updates may leave the system in an unknown, and possibly inoperable, state. Common failures during this process include interruptions such as run-time failures or abnormal termination of the execution of binary programs or applications. Causes of such failure include power outages during binary execution, local software configuration or compatibility issues leading to abnormal binary execution or termination, local software corruption, etc. Further, tracking what the binary may change on the hard drive image during the update is extremely difficult, and may result in the actual state of the OS differing significantly from a projected or desired state of the OS after the update has been applied. In addition, in the event of an update failure, previously customized or personalized user states or data may no longer be accessible, even following an attempted update rollback.

Unfortunately, typical update services also often suffer from nondeterministic scheduling and non-differentiation of stock keeping units (SKUs). For example, with respect to differing SKU's, some devices (or different device hardware versions) may work better with particular updates than other devices. With the exception of driver updates, many OS or system level updates simply do not consider differing SKU's, and thus simply apply the same updates to different devices, with results that are sometimes unexpected.

Additionally, generating different sub-system or application level updates can be problematic when updates for the main OS are involved. Generally, these updates are installed under the security context of a “Trusted Installer” or the like that limits the bits that are installed to only those bits that are signed by a private key. Similarly, installing an entire image of the OS often involves reset-to-factory settings and can be problematic. For example, if the local hard drive image has been “dirtied,” the factory reset may be a very operation costly (i.e., download and install time and bandwidth costs), especially if the entire factory image is to be acquired from the cloud or other network source and then copied or installed in place.

Some of the aforementioned problems are further compounded where updates are to be applied to a group of common devices. More specifically, some or all of the devices in such groups may be in different states (OS and/or applications) and thus require different updates to reach the current version. Further, various files used to customize OS operation may be changed by the user (e.g., personalization information, computer name, network domain membership, language settings, etc.). Consequently, updating groups or fleets of particular devices becomes increasingly difficult or labor intensive as the number of devices increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of prior technologies may be noted or discussed herein, the claimed subject matter is not intended to be limited to implementations that may solve or address any or all of the disadvantages of those prior technologies.

In general, a “Zero-Touch Manager” or “ZTM,” as described herein, provides various techniques for supplying updates to a device's firmware, operating system (OS), frameworks, applications, etc., from cloud-based or other storage accessible via the Internet or other network. The ZTM provides updates in a manner that ensures that groups of one or more “identical” devices (i.e., same device hardware version) are all running from the same known state. Advantageously, the update processes enabled by the ZTM also provide various techniques for maintaining local customizations (e.g., personalization information, computer or device names, network domain memberships, language settings, etc.) for individual devices following updates.

More specifically, in various embodiments, the ZTM maintains one or more Virtual Hard Disks (referred to herein as “VHD's” or “update VHD's”) containing an image of an “update version” comprising an operating system and/or application stack (also referred to as a “system image”) in cloud storage (or other Internet or network accessible storage mechanism). These VHD's can then be provided to one or more devices or groups of devices to update (or roll back) those devices to a desired “update version” by using the VHD to replace or update the existing local hard drive image on each device. Further, since VHD's represent hard drive images, VHD's can be prepared as bootable disk images, such that mounting and booting to a VHD will boot a device just like any locally installed hard drive having an OS for the device. However, there is no requirement for VHD's to be bootable.

Note that the state (or version) of the OS and/or application stack of each device is referred to herein as the “local hard drive image.” Note also that while the update process is generally described in terms of updating the OS and/or application stack for devices, the techniques described herein may also be used to update the firmware of such devices.

In various embodiments, the ZTM constructs one or more “differential update versions” (each referred to herein as a “diff”) of the update VHD relative to a reference copy (or “reference system image”) of a current version of each known or possible local hard drive image for each device. In other words, diffs are constructed using the differences that exist between the image of the update VHD and one or more versions of the OS and/or application stack corresponding to the local hard drive image of each device. Further, in various embodiments, the ZTM uses sector-level differences between the image of the update VHD and the local hard drive image to create the diffs. In other words, in such embodiments, each diff includes those sectors that change between the update VHD and the version of the local hard drive image. Other techniques, including, but not limited to, Remote Differential Compression (RDC) can also be used by the ZTM to create diffs.

Consequently, updates to the local hard drive image are achieved by simply replacing any sectors of the local hard drive image that have corresponding sectors in the diff, though additional information may also be included in the diff and used to update the local image, if desired. Note that in the case that all sectors of the update VHD have changed relative to the version of a local hard drive image, the resulting diff will be equivalent to the complete update VHD.

Further, in various embodiments, the ZTM provides “manifest files” that are generally used to map particular device hardware/software versions to the appropriate diff for updates. Consequently, devices use information contained in the manifest files to detect, download and apply differential updates to any combination of the firmware, OS, etc., of each device.

In view of the above summary, it is clear that the ZTM described herein provides various techniques for supplying updates to an embedded device's firmware, operating system, frameworks, applications, etc., from cloud-based or other storage accessible via the Internet or other network. In addition to the just described benefits, other advantages of the ZTM will become apparent from the detailed description that follows hereinafter when taken in conjunction with the accompanying drawing figures.

### DESCRIPTION OF THE DRAWINGS

The specific features, aspects, and advantages of the claimed subject matter will become better understood with regard to the following description, appended claims, and accompanying drawings where:

FIG. 1 provides a general summary of a process for updating the firmware and/or the OS and/or application stack of one or more groups of devices by applying differential updates (diffs) to local hard drive images of each device using a “Zero-Touch Manager” or “ZTM,” as described herein.

FIG. 2 provides an exemplary architectural flow diagram that illustrates program modules for generating and supplying diff-based updates to current versions of device firmware and/or the OS and/or application stack from cloud-based or other Internet or network-based storage using the ZTM.

FIG. 3 illustrates an example of an embodiment of the ZTM wherein devices use multiple VHD's and alternate bootable chains of hard drives or VHD's, thereby allowing the ZTM to be booted into one chain while updating one or more VHD's in the other chain using diffs, as described herein.

FIG. 4 provides a general system flow diagram that illustrates exemplary methods for implementing various embodiments of the ZTM, as described herein

FIG. 5 provides a general system diagram depicting a simplified general-purpose computing device having simplified computing and I/O capabilities for use in implementing various embodiments of the ZTM, as described herein.

### DETAILED DESCRIPTION OF THE EMBODIMENTS

In the following description of the embodiments of the claimed subject matter, reference is made to the accompanying drawings, which form a part hereof, and in which is shown by way of illustration specific embodiments in which the claimed subject matter may be practiced. It should be understood that other embodiments may be utilized and structural changes may be made without departing from the scope of the presently claimed subject matter.

1.0 Introduction:

Note that the term “device” as used throughout this document is intended to refer to any computing device, including, but not limited to, robotic devices, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

In general, a “Zero-Touch Manager” or “ZTM,” as described herein, provides various techniques for supplying updates to current versions of device firmware, operating system (OS), frameworks, applications, etc., (collectively referred to herein as the “OS and/or application stack” or “system image”) from cloud-based or other Internet or network-based storage. These updates ensure that groups of one or more “identical” devices (i.e., same device hardware version) run from the same known state, while maintaining local customizations for individual devices, if desired.

More specifically, Virtual Hard Disk (VHD) images representing “update versions” of the OS and/or application stack are constructed and used as part of the process of updating individual devices to a desired version. However, rather than provide an entire update VHD image to individual devices for update purposes, the ZTM instead provides the updates in the form of “differential update” versions (referred to herein as “diffs”). Diffs are constructed by differencing the image of the update VHD and a reference copy (or “reference system image”) of the local hard drive image of each device (which depends on the current version of the device). Further, since VHD's represent hard drive images, VHD's can be prepared as bootable disk images, such that mounting and booting to a VHD will boot a device just like any locally installed hard drive having an OS for the device. In other words, VHD's may be bootable, though there is no requirement for any of the VHD's to be bootable. Note that while the term “hard drive” is used throughout this document, it should be understood that this term is intended to include any bootable or non-bootable storage device, including, but not limited to, physical hard drives, solid state drives, optical drives, virtual or ram-based drives, etc.

In various embodiments, the ZTM uses sector-level differences between the update VHD image and the local hard drive image to construct the diffs. Note also that related differencing techniques, including, but not limited to, Remote Differential Compression (RDC) can be used to create diffs. In general, each diff includes the changes between the version of the update VHD and the version of the local hard drive image, rather than an entire disk image. This allows the ZTM to update devices to a new version by simply replacing any sectors or changed portions of the local hard drive image that have corresponding sectors or changed portions in the diff, though additional information may also be included in the diff, if desired.

Further, in various embodiments, “manifest” files are used to control device updates based upon the current version of the local hard drive image relative to one or more update (or roll back) versions of the OS and/or application stack available via the diff. In general, the manifest files provide one or more paths from the current version of the individual device to one or more versions enabled by the diff. This allows a single manifest file either to be used with a single diff applicable to multiple update scenarios, or to be used with a plurality of diffs that are each designed for single update scenarios.

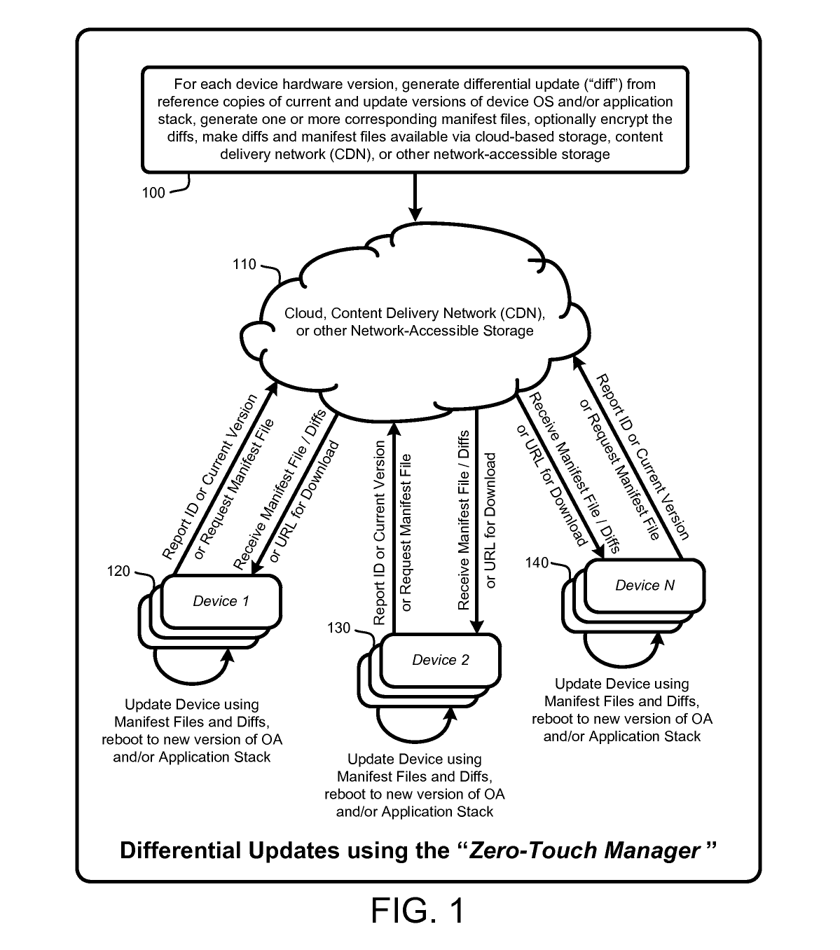

FIG. 1 provides a general summary of the processes discussed above for updating the firmware and/or the OS and/or application stack of one or more devices (120, 130, 140) by applying diffs to local hard drive images of each device using the ZTM. In particular, element 100 shows that for each device hardware version of each device (120, 130, 140), the ZTM generates a differential update (“diff”) that encapsulates any drive image differences between an update version of the OS and/or application stack and reference copies of current (or previous) versions on each device. The ZTM then generates one or more corresponding manifest files, and optionally encrypts the diffs. The ZTM then uploads the diffs and manifest files to one or more content delivery networks (CDN's) or cloud-based or other network-accessible storage sites that are accessible to individual devices.

Next, each device or group of devices (120, 130, 140) periodically (or on request) either reports an ID or information corresponding to its hardware and/or OS and/or application stack version or simply requests an updated manifest file from a predetermined url or network address. If a new or updated manifest file and corresponding diff are available, the device or group of devices (120, 130, 140) then downloads the manifest file and evaluates the manifest file to determine which diffs to download. The device or group of devices (120, 130, 140) then downloads the proper diff and uses that diff to update its local hard drive image to the new version of the OS and/or application stack represented by the diff.

More specifically, there are a wide variety of ways in which devices of a particular hardware version and OS and/or application stack version can identify and download the proper diff for updates. For example, in the context of a content delivery network (CDN), individual devices will check a particular network address or url (generally preconfigured for the current version of the OS and/or application stack) that is associated with the CDN to determine whether a new or updated manifest file is available. If a new manifest file is available, the CDN will respond to the device with a network address or url (typically one that is either near the device, or has available bandwidth to process the request) where the device can download the manifest file. The device then downloads the manifest file, processes the manifest file, and contacts the CDN (or other network address or url specified in the manifest file) to request the diff identified by the manifest file for use in updating the current version of the OS and/or application stack of the device. In the case that the device contacts the CDN for a diff, the CDN will again respond to the device with a network address or url (typically one that is either near the device, or has available bandwidth to process the request) where the device can download the diff. Finally, each device (120, 130, 140) then updates its local hard drive image using the downloaded diff and reboots into the new version of the OS and/or application stack corresponding to the downloaded manifest files and diffs.

To summarize, the ZTM applies some or all of the following techniques to enable device updates:
VHD's specific to particular device hardware versions are used as a baseline of the OS and/or application stack for each device;
Devices having the same hardware version share a “cloned” hard drive image, e.g., a base VHD that corresponds to the same version of the OS and/or application stack;
Local changes or customizations written to the hard disk of a device may be stored as a diff, or to one or more partitions or data stores separate from the OS and/or application stack, so that this information can be used to maintain local persistent states following updates.
In various embodiments, devices are configured with the capability to boot or mount two or more VHD's to assist in the update process, as discussed in further detail herein;
All local changes on a device can be easily reverted to a default state or version by simply replacing the entire local hard drive image that contains the OS and/or application stack with a different VHD, or by updating the local hard drive image without rolling forward some or all local customization information.
Updates are provided to devices in the form of diffs identified by one or more manifest files;
Firmware images may also be included in the diffs, or included as separate diffs or images, for use in updating device firmware, either with or without updates to the OS and/or application stack.

1.1 System Overview:

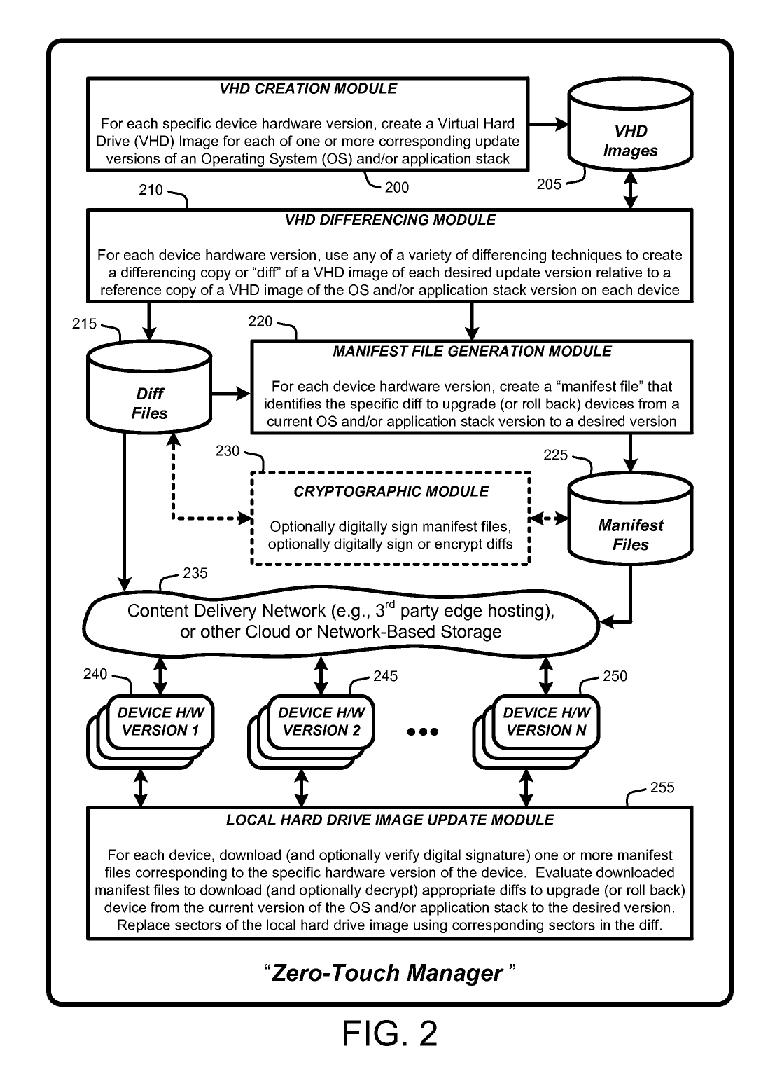

As noted above, the ZTM provides various techniques for generating and supplying diff-based updates to current versions of device firmware and/or the OS and/or application stack from CDN's, or cloud-based or other Internet or network-based storage. The processes summarized above are illustrated by the general system diagram of FIG. 2. In particular, the system diagram of FIG. 2 illustrates the interrelationships between program modules for implementing various embodiments of the ZTM, as described herein. Furthermore, while the system diagram of FIG. 2 illustrates a high-level view of various embodiments of the ZTM, FIG. 2 is not intended to provide an exhaustive or complete illustration of every possible embodiment of the ZTM as described throughout this document.

In addition, it should be noted that any boxes and interconnections between boxes that may be represented by broken or dashed lines in FIG. 2 represent alternate embodiments of the ZTM described herein, and that any or all of these alternate embodiments, as described below, may be used in combination with other alternate embodiments that are described throughout this document

In general, as illustrated by FIG. 2, the processes enabled by the ZTM begin operation by using a VHD creation module 200 to create a Virtual Hard Drive (VHD) Image 205 (also referred to as VHD's 205) for each of one or more corresponding update versions of an OS and/or application stack for each specific device hardware version. As discussed in further detail in Section 2.2, one or more VHD's 205 are created for a particular device hardware version by installing the OS and/or application stack onto a reference copy of the device. The newly installed OS and/or application stack is then used to create the VHD image 205 that can be used for updates of all other instances of the device that have the same hardware and/or firmware version.

For each device hardware version, the ZTM then uses a VHD differencing module 210 to create sector-level diffs 215 by differencing the sectors of a VHD image 205 of each desired update version relative to the sectors of a reference copy of a VHD image of the OS and/or application stack version installed on each device. Note that diffs 215 are discussed in further detail in Section 2.3.

Next, again for each device hardware version, the ZTM uses a manifest file generation module 220 to create one or more manifest files 225 that generally identify the specific diffs 215 to be used update (or roll back) particular devices from a current OS and/or application stack version to a desired version. More specifically, the ZTM uses the information contained in the manifest to determine whether updates are available, download the appropriate diffs 215 and apply differential updates to device firmware, operation systems, applications, etc. Note that manifest files 225 are discussed in further detail in Section 2.4.

In various embodiments, the ZTM provides additional security for various purposes by generating signed or encrypted diffs 215. More specifically, the ZTM uses an optional cryptographic module 230 to encrypt or otherwise digitally sign the diffs 215. For example, the diffs 215 can be created using public/private key cryptography, with the corresponding manifest files containing information such as cryptographic checksum or cryptographic hash information and version numbers for downloading, verifying, and decrypting the diffs. Note that any desired form of encryption can be used for such purposes. Advantageously, the use of digital signatures and cryptographic techniques allows the ZTM to use otherwise unsecured or public cloud-based storage or other unsecured content delivery networks.

Once the diffs 215 and manifest files 225 have been generated, they are uploaded or otherwise stored to cloud or network-based storage 235 or made available via one or more CDN's or the like.

Finally, for each device (e.g., 240, 245, 250) having the same hardware version, the ZTM uses a local hard drive update module 255 to provide updates to those devices from the cloud or network-based storage via the aforementioned diffs. More specifically, for each device, the ZTM either pushes or allows the device to download (and optionally decrypt) one or more manifest files to the device that corresponds to the specific hardware version of the device.

The local hard drive update module 255 (optionally running locally on each device) then evaluates the downloaded manifest files to determine the appropriate diffs to download (and optionally decrypt) to update (or roll back) the device from its current version of the OS and/or application stack to the desired version. As noted above, and as discussed in further detail in Section 2.5, these updates are enabled by using the diffs to replace the sectors of the local hard drive image that have changed relative to the sectors of the desired version of the OS and/or application stack contained in the diff.

2.0 Operational Details of the ZTM:

The above-described program modules are employed for implementing various embodiments of the ZTM. The following sections provide a detailed discussion of the operation of various embodiments of the ZTM, and of exemplary methods for implementing the program modules described in Section 1 with respect to FIG. 1 and FIG. 2. In particular, the following sections provides examples and operational details of various embodiments of the ZTM, including: an operational overview of the ZTM; creation of VHD images; diff construction; manifest files; device updates using diffs; and cloud Blob storage with optional cryptographic enhancements.

2.1 Operational Overview:

As noted above, the ZTM-based processes described herein provide various techniques for generating and supplying diff-based updates to current versions of device firmware, and/or the OS and/or application stack from cloud-based or other Internet or network-based storage while maintaining local customizations for individual devices. The ZTM uses diffs to update the local hard drive image of each device to correspond to an image of the desired update version. For example, by updating the local hard drive image of a device by replacing sectors of that image with changed sectors from the diff, devices can be quickly updated (or rolled back) to any desired version of the OS and/or application stack. The ZTM also uses manifest files in combination with the diffs to control device updates based upon the current version of the local hard drive image relative to update versions in the diff.

In general, the ZTM minimizes the need for devices to determine which updates to apply and when to apply those updates. In various embodiments, this is accomplished by causing each device to periodically (or upon command) report or otherwise send information detailing the current version of the OS and/or application stack of the device to a remote service component of the ZTM (e.g., cloud-based or other remote server or computing device). The remote service component of the ZTM then determines which manifest file is to be used to update (or roll back) the OS and/or application stack of the device to some desired version. Note also that in the case that multiple updates are available, the remote service component can return a list of the available updates to the device for a local determination of which updates to apply.

In either case, once the update version (and local version) are known, the appropriate manifest files and corresponding diffs are provided to the device. In various embodiments, the device then exposes an editable local copy of a base or factory OS image (e.g., a local hard drive image or VHD of the OS and/or application stack having a known version or base state). The diff is then applied to that local hard drive image or VHD (by replacing changed sectors) to create an updated hard drive image or VHD. The device is then rebooted to the updated hard drive image or VHD to complete the update process.

The update techniques summarized above offer a number of advantages over conventional update techniques. For example, complete VHD images can be very large (ranging in size from megabytes to terabytes), depending upon the size of the OS and application stack. However, diffs are generally much smaller than the entire update VHD, with the result that bandwidth and download times for transmitting a diff to any device are generally significantly decreased relative to transmitting the entire update VHD.

Further bandwidth and download time savings are achieved in various embodiments by compressing diffs (using any desired compression technique) prior to transmission to individual devices. In addition, the use of cryptographic techniques to digitally sign the manifest files and optionally sign or encrypt the diffs allows the ZTM to provide secure distribution of updates to devices via cloud-based storage services or other untrusted content delivery network (CDN).

In addition, the sector-replacement mechanism using the diff allows the ZTM to update the local hard drive image without the need to execute binaries or other applications in the manner generally seen with existing update services. As such, these updates are generally much faster than running update programs or installing new OS or application software by executing install binaries or the like. Further, updates will not fail if completed, and updates can be performed in a manner that is transparent to user.

2.2 VHD Images for Update Versions:

The ZTM maintains images of one or more Virtual Hard Disks (referred to herein as “VHD's” or “update VHD's”) in cloud storage (or other Internet or network accessible storage mechanism). Each VHD contains an image of a particular version of an OS and/or application stack tailored to a particular instance of a device having a particular hardware version. These VHD's are used to provide updates to one or more groups of devices to update (or roll back) those devices to a desired “update version” by replacing or updating the existing local hard drive image on each device.

The ZTM also maintains reference copies of VHD images of one or more prior versions OS and/or application stack for each device type and hardware version. Further, as noted above, VHD's represent hard drive images. Therefore, the ZTM can prepare VHD's as bootable disk images, if desired, such that mounting and booting to a VHD will boot a device just like any locally installed hard drive having an OS for the device. In other words, VHD's can be bootable (e.g., mount the VHD to a virtual machine (VM) and boot into the image). Further, it should be noted that in various tested embodiments, one or or more of the devices to be updated via the ZTM included multiple physical/virtual disks on the device, with only some of those disks being bootable.

More specifically, each VHD is created for a particular device hardware version by installing the OS and/or application stack onto a real or virtual (e.g., device simulator or emulator) reference copy of the device of the particular hardware and/or firmware version. Once the OS and/or application stack has been installed onto the reference copy of the device, the OS and/or application stack on that device is optionally configured and tested (manually or automatically) to any extent desired to verify proper operation and configuration of the software and hardware of the device. Next, whether or not proper operation has been optionally verified, the OS and/or application stack installed on the reference copy of the device is used to create a version-specific VHD that can be used for updates of all other instances of the device that have the same hardware and/or firmware version.

One advantage to creating VHD's in the manner described above is that a single instance of a particular hardware version of a specific device of can be carefully updated, configured, and optimized for any desired OS and/or application stack. Once satisfied that the software configuration is correctly adapted or configured for the particular hardware, an image of the hard drive (i.e., an update VHD) representing that current configuration is created by copying the corresponding drive partition. This same update VHD can then be used (via the aforementioned diffs) to update any number of devices having the same hardware version without individually configuring or adapting the OS and/or application stack to any of those devices.

Further, by maintaining reference copies of previously generated VHD's for each version of the OS and/or application stack for each specific device hardware version, the ZTM has all of the information that it needs to create the aforementioned diffs. In particular, this information allows the ZTM create diffs to update (or roll back) any device hardware version to any desired version of the OS and/or application stack. Again, as discussed in further detail in Section 2.5, these updates are enabled by using the diffs to replace the sectors of the local hard drive image that have changed relative to the sectors of the desired version of the OS and/or application stack contained in the diff.

2.3 Diff Construction:

As noted above, in various embodiments, the ZTM generates one or more differential update versions (i.e., “diffs”) of one or more of the update VHDs relative to a current version of each known or possible local hard drive image for each device. In other words, diffs are constructed using the differences that exist between the version of the update VHD and a reference copy of the version of the local hard drive image. It should be understood that since diffs are constructed based on the differences between hard drive images, diffs can typically be used as updates only to a binary identical parent image, though there may be possible exceptions to this rule for closely related hard drive images.

In general, the ZTM uses various ‘diffencing copy’ or ‘delta copy’ technology to produce diffs that contain the bits that change from one version to another, rather than adding entire files to the diff just because some part of that file has been changed. Such techniques tend to reduce the number of modified sectors touched, with a corresponding reduction in the size of the diff.

For example, in various embodiments, the ZTM uses sector-level differences between the update VHD and the local hard drive image to create the diffs. In other words, in such embodiments, each diff includes those sectors that change between the update VHD and the reference copy of the version of the local hard drive image. Further, as noted above, diffs are optionally digitally signed or encrypted, and may optionally be compressed prior to transmission to individual devices.

In addition, in various embodiments, the ZTM uses any of a variety of ‘differencing copy’ or ‘delta copy’ type differencing techniques, including, but not limited to, Microsoft® Remote Differential Compression (RDC) or UNIX RSync, to minimize the number of sectors touched when a file was changed, thereby reducing the byte size of the resulting diff.

RDC generally acts to determine the differenecs between to files (or entire disk images in the case of the ZTM) by fingerprinting blocks on each of two copies or versions of a file. However, since many types of file changes can cause the file contents to move (for example, a small insertion or deletion at the beginning of a file can cause the rest of the file to become misaligned to the original content) the blocks used for comparison are not based on static arbitrary cut points (e.g., disk sectors) but on cut points defined by the contents of each file segment. This means that if a part of a file changes in length or blocks of the contents get moved to other parts of the file, the block boundaries for the parts that have not changed remain fixed related to the contents, and thus the series of fingerprints for those blocks don't change either, they just change position. By comparing all hashes in a first version of a file to the hashes for a second version of the file, RDC is able to identify which blocks of the file have changed and which haven't, even if the contents of the file has been significantly reshuffled. This information is then used to construct the diff based on the actual bit changes between the files, even if those files have been reshuffled.

For example, if a 4 GB file is comprised of one million 4 KB sectors and it was modified but only in the last 4 KB sector, ‘delta copy’ technology such as RDC would cause the VHD diff to only touch one 4 KB sector when creating the diff, not all sectors of the 4 GB file. Without this type of approach diff updates would tend to be much larger than a strictly sector-based or file-based diff.

Note that in the case that all sectors of the update VHD have changed relative to the reference copy of the version of the local hard drive image, the resulting diff will be equivalent to the complete update VHD (which may be bootable, as noted above). Complete update VHD's or diffs are used for device updates in instances where changes to the OS and/or application stack are so extensive that it is simpler to just replace the entire local hard drive image rather than most or all of the individual sectors of that image.

Advantageously, when diffs are constructed based on successive updates to a common parent VHD, those Diffs can be chained or merged into a single diff that contains all changed sectors for the successive updates.

2.4 Manifest Files:

In general, manifest files can be thought of as defining an update path that specifies which diffs are to be used to update particular devices having a particular hardware version and a particular version of the OS and/or application stack. Further, the manifest file may also provide a url or address from which the device is to request the diff. In other words, manifest files are generally used to map particular device hardware/software versions to the appropriate diff for updates, and particular manifest files may be applicable to multiple device hardware/software combinations.

As part of the overall update process, devices periodically (or on demand) poll a predetermined or embedded url or other network address to determine whether any new or updated manifest files are available. Advantageously, this allows individual devices to perform the evaluation as to what updates are available rather than having some remote service perform this roll by evaluating the current configuration of the device. In other words, devices periodically check to see whether new manifest files are available. If so, the device downloads the new manifest file, evaluates that file to determine what updates are available for its current hardware version and current verison of the OS and/or application stack, and then downloads the appropriate diffs tp perform the update locally. Note also that updates to the device can also be used to change the predetermined or embedded url or network address for checking for new manifest files for subsequent updates. Consequently, during the update process, devices of particular hardware and software configurations can be pointed to different update addresses for future updates, if desired.

As noted above, diffs are used to update (or roll back) the local hard drive image of a device to a desired version represented by the diff. Consequently, given the large number of possible variations between the current hardware and software versions of any particular device and the desired update version, manifest files are generally constructed to include multiple sets of rules that define update paths (and corresponding diffs) to update (or roll back) any particular device from its current version of the OS and/or application stack to any desired version. This allows a single manifest file either to be used in combination with a single diff applicable to multiple update scenarios, or to be used with a plurality of diffs that are each designed for one or more specific update scenarios.

For example, assume that three instances of the same device hardware version each need to be updated to “version 2” of an OS and/or application stack. Further assume that each of these devices have different versions of the OS and/or application stack (e.g., Device A with version 1.1, Device B with version 1.2, and Device C with version 1.3). In this case, the ZTM can create either a single manifest file that provides three separate update paths (i.e., version 1.1 to version 2, version 1.2 to version 2, and version 1.3 to version 2), or separate manifest files that are specific to both the version of each device and the desired update version.

However, in various tested embodiments of the ZTM, it was observed that creating fewer numbers of manifest files that were applicable to larger numbers of device hardware and software versions or configurations tended to be a simpler operation than maintaining separate versions of manifest files for every possible hardware and software version for particular devices. In either case, each device downloads the appropriate manifest file and then uses it to select the appropriate update path for downloading one or more corresponding diffs. Each device then uses the information in the manifest file and diffs to replace the changed bits or sectors on each device to update (or roll back) the OS and/or application stack of the device to the desired version, as described in further detail in Section 2.5.

Further, it should also be understood that the ZTM can also perform any desired sequence of update stages to bring any particular device to a desired version. For example, continuing with the example provided above, Device A with version 1.1 could be updated from version 1.1 to 1.3 (skipping 1.2) then from 1.3 to version 2. Alternately, Device A with version 1.1 could be updated from version 1.1 directly to version 2. In other words, it should be understood that updates do not need to be linear, and that manifest files having any desired update path can be created. However, it is clearly advantageous to create manifest files that include update paths that minimize the diff download size (and thus bandwidth) requirements.

Additional security is provided in various tested embodiments by digitally signing manifest files after they are created. Advantageously, the use of digital signatures allows the manifest files (and optionally encrypted diffs) to be published to untrusted or public cloud storage such as Windows® Azure™ Drive or other content delivery networks. In addition, compression of either or both the manifest files and diffs can be performed if desired.

2.5 Device Updates Using Diffs:

As noted above, updates to the local hard drive image are achieved by simply replacing any changed bits or sectors of the local hard drive image that have corresponding changed sectors in the diff, though additional information may also be included in the diff, if desired. This diff-based update mechanism allows the ZTM to update the local hard drive image without the need to execute binaries or other applications in the manner generally seen with existing update services. Further, as noted above, determination of whether updates are available are performed locally on each device (via the manifest files) rather than making this determination remotely, as is done with many traditional update scehemes.

Given that updates are performed by modifying the local hard drive image, this can be accomplished in a variety of ways. For example, in various embodiments, the ZTM performs updates while already booted into a first drive or VHD on the device by mounting a second drive or VHD (having either the same or different version of the OS and/or application stack as the first drive or VHD). The ZTM then uses the diff to apply updates to the OS and/or application stack on the second drive. The device can then run the newly updated OS and/or application stack by simply rebooting into the second drive or VHD instead of the first drive or VHD.

In other words, devices do not need to be taken offline or otherwise inconvenience the user during updates, since updates are performed while the device is booted into a first image of the OS and/or application stack by simply mounting and manipulating the state of a second or alternate image of the OS and/or application stack. A simple mounting and reboot into the newly updated OS and/or application stack then runs the new version of the OS and/or application stack without further manipulation or changes to any hard drive or VHD. Consequently, it should be understood that while running any version of the OS and/or application stack, the device can separately mount one or more copies of any version of the OS and/or application stack which can thnen be updated to the desired OS and/or application stack using corresponding manifest files and diffs.

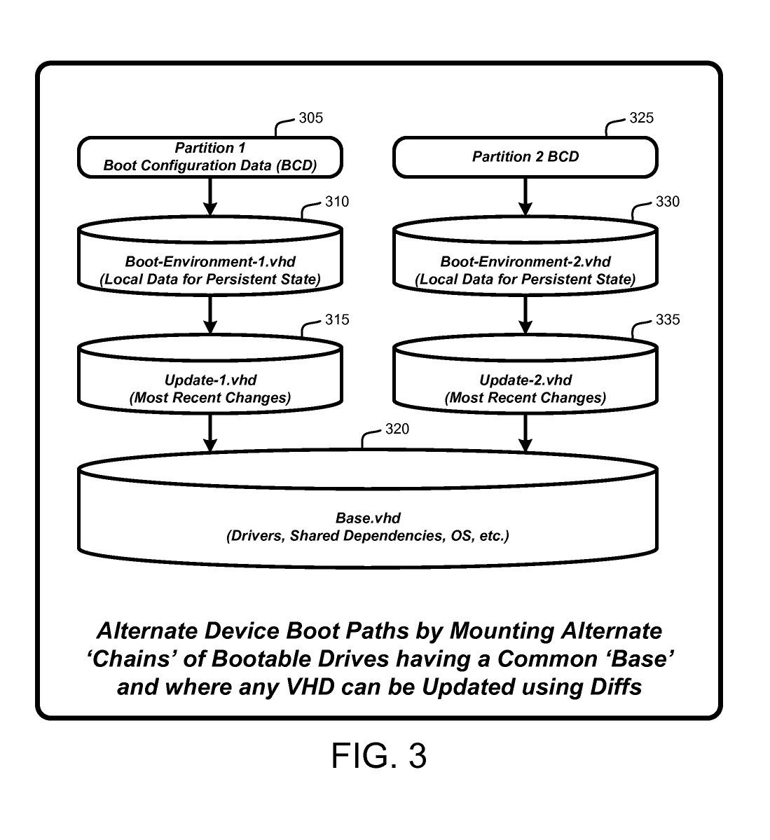

These techniques are further expanded by in various embodiments by providing multiple VHD's that are used by individual devices to provide two or more alternate ‘boot chains’ of VHD's. Any of the VHD's in any chain, other than the chain that is currently booted and running on the device, can be updated using diffs. For example, FIG. 3, illustrates an embodiment of the ZTM wherein a device uses multiple VHD's and two alternate bootable chains of VHD's, thereby allowing the ZTM to be booted into one chain while updating one or more VHD's in the other chain using diffs, as described herein.

In the example of FIG. 3, the first bootable chain is comprised of three VHD's (310, 315 and 320) chained as specificed by boot configuration data (BCD) for “Partition 1” (305) while the second bootable chain is also comprised of three VHD's (330, 335, and 320) chained as specificed by the BCD for “Partition 2” (325). Note that while not required, in this example, both chains share VHD 320 (i.e., “Base.vhd,” containing various drivers, shared dependencies, OS elements, etc.). The device can boot to either chain, i.e, the chain specified by the “Partition 1” (305) BCD, or the chain specified by the “Partition 2” (325) BCD. In either case, the device will boot to the preferred boot chain (or a chain specified by a downloaded manifest file), then mount the other boot chain or one or more of the VHD's in that chain. The ZTM will then update one or more of the VHD's in the chain that is not booted by applyingthe diffs to those VHD's, as discussed above. Note that in the case that the shared VHD 320 (i.e., “Base.vhd”) is to be updated using diffs, the device can boot to another alternate boot drive or chain (not illustrated) that allows modification to the shared VHD.

In addition, in the case that major changes have occurred between the version of a particular device and the current update version, it may be preferable to download a diff that provides an entirely new disk image to a particular device for update purposes. For example, assume that a device having version 1 of an OS and/or application stack is offline for 2 years, and upon going online and reporting its current version, the ZTM determines that an update of the device to version 12 of the OS and/or application stack is desired. In this case, providing a complete hard drive image for version 12 of the OS and/or application stack may be preferable to an update path that incrementally updates the device from version 1 to version 12. Alternately, it may be preferable to provide an update path, for example, that updates version 1 to version 10 (using a complete hard drive image for version 10 of the OS and/or application stack) followed by differential updates, via sector replacements, from version 10 to version 12.

2.5.1 Exemplary VHD-Based Approach to Updates:

In general, the preceding discussion generally described updating the OS and/or application stack represented by the local hard drive image on a primary boot partition. However, many devices make use of a boot partition in combination with a plurality of additional drives, including separate partitions, separate drive volumes or physical drives, VHD's that can be mounted and accessed as logical drives by the device, etc. The ZTM is capable of using the techniques described herein for updating any or all such drives, individually or in combination, using one or more corresponding manifest files and diffs. In other words, the ZTM is fully capable of sequentially or concurrently updating any combination of bootable or non-bootable partitions, drive volumes, virtual drives (e.g., ram disks or the like), separate hard drives, VHD's, etc., on any device. Note that for purposes of explanation, the term “partitions” is used throughout this document to collectively refer to any bootable or non-bootable partitions, drive volumes, virtual drives (e.g., ram disks or the like), separate hard drives, VHD's, etc.

One advantage to the use of multiple partitions is that the OS and/or application stack of a particular device can be stored on one or more partitions (e.g., a local boot partition), while local data or customizations (e.g., personalization information, computer name, network domain membership, language settings, etc.) can be stored on a separate partition. This allows the ZTM to maintain local data or customizations between updates, as discussed in further detail in Section 2.5.2.

Further, in various embodiments, one or more local copies of factory or master versions of particular VHD images are locally stored by various devices in one or more local partitions. As such, locally stored factory or master VHD's can be used for replacing the bootable local hard drive image, or as a baseline for updates using downloaded diffs, regardless of the current state of the bootable local hard drive image. Such embodiments allow the device to revert to a default setting or state, or to update to a new version regardless of any changes (including, for example, corruptions such as infections by one or more computer viruses) that may have occurred to the bootable local hard drive image.

2.5.2 Maintaining Local Customizations Following Updates:

Computing devices are often customized, at least in part, with user- or location-specific information including, but not limited to personalization information, computer or device name, network domain membership, language settings, etc. Such information is referred to herein as a “persistent state” since it is intended that the state of local customizations persists on individual devices following the update process.

Where customizations are local (i.e., on a per-device basis), the ZTM acts to roll forward any existing customization data as part of the overall update process. More specifically, in various embodiments, the ZTM acts to roll forward local customizations for each device by ensuring that the boot environment of each device includes the same local customizations post-update as it did pre-update. In general, this is accomplished by ensuring that any new version of the OS and/or application stack will boot to the same persistent state (i.e., local customizations) as the current OS and/or application stack of the device following the update process.

For example, where local customization information is integrated into the same partition as the OS and/or application stack, maintaining a persistent state following updates is achieved by reading the local customization information and then writing or storing that information to one or more separate local or remotely accessible data stores. Then, following updates to the local hard drive image, the ZTM reads back the local customization information and further updates the updated local hard drive image by integrating the local customization information into the updated image. Consequently, following reboot, the device will boot to a new version of the OS and/or application stack that exhibits the same persistent state as the OS and/or application stack prior to the update process.

In related embodiments, local customization information is maintained in one or more partitions (real or virtual) that are separate from the partition of the OS and/or application stack. Consequently, during operation, each device will boot into the partition of the OS and/or application stack, and then use a pointer or the like to access the data stores containing the local customization information to personalize the device during the boot process. Then, following updates of the OS and/or application stack using manifest files and diffs, the ZTM further modifies the updated local hard drive image (if necessary) to point to the local customization information. Consequently, following reboot, the device will boot to a new version of the OS and/or application stack that exhibits the same persistent state as the OS and/or application stack prior to the update process.

More specifically, devices may be configured to use a boot pointer or the like to point the OS and/or application stack to an initial boot environment (e.g., “Boot-1”) on a particular partition (e.g., “Partition-1”) of a device to populate a persistent state of the current OS and/or application stack with local customization information. In this case, during the update process, the ZTM constructs a new boot environment (e.g., Boot-2), that is applicable to the updated OS and/or application stack, in a new partition (e.g., “Partition-2”) using local customization information automatically extracted from Boot-1. The ZTM then changes the boot pointer in the updated OS and/or application stack to point to Boot-2 on Partition-2. Consequently, following reboot, the device will boot to the updated OS and/or application stack that exhibits the same persistent state as the OS and/or application stack prior to the update process by using the local customization information from Boot-2. Alternately, Boot-2 in Partition-2 can be used to overwrite or otherwise replace Boot-1 in Partition-1 following the update to the OS and/or application stack without needing to change the boot pointer.

For example, the ZTM can send manifest files and update diffs to a device while the device is running a current version of the OS and/or application stack that uses local customization information in Boot-1. The ZTM then uses the diffs to apply updates to a local copy of the OS and/or application stack as described above. Then, while still running the current version of the OS and/or application stack under Boot-1, the ZTM creates Boot-2 in a separate partition and sets a pointer in the updated OS and/or application stack to Boot-2. The device is then rebooted to the updated OS and/or application stack, and since the pointer now points to Boot-2, the next time the device is rebooted, it will boot to the updated OS and/or application stack and the same persistent state now encapsulated in Boot-2. One advantage of this process is that the ZTM maintains the local customizations across updates to the OS and/or application stack while only requiring one reboot of the device (though multiple reboots could be performed if desired for some reason).

Finally, note that user data other than system level customizations, such as, for example, documents, game scores, contact lists, etc., can be stored on different partitions from the OS and/or application stack such that this information is maintained between updates. Note that pointers to this information may also be updated in the updated version of the OS and/or application stack, if necessary

2.6 Cloud Blob Storage:

In various embodiments, the ZTM generates the diffs using a “Blob” (Binary Large Object) format, though any other desired format may also be used. As is known to those skilled in the art, Blobs provide a mechanism for storing large amounts of unstructured text or binary data such as hard disk images, video, audio, etc. Further, Blobs are an ISO 27001 certified managed service that can auto-scale to meet massive throughput and volume (currently up to 100 terabytes, though it should be understood that Blob size may be increased). In addition, Blobs can be made accessible from virtually anywhere via REST (representational state transfer) or other protocols, and may be managed using conventional API's or the like. Advantageously, Blobs can also be mounted as drives (i.e., Blobs can be formatted as bootable drive images). For example, cloud-based services such as Windows® Azure™ Drive allow applications (such as the ZTM) to mount a Blob formatted as a single volume NTFS virtual machine (VM). Further, VMs can be moved between private and public clouds using Windows® Azure™ Drive or other cloud-based services.

Cloud storage is often used as the foundation for public or untrusted content delivery networks (CDN's) that are accessible by large numbers of users or devices. Consequently, in various embodiments, the ZTM uses digitally signed manifest files in combination with diffs that may also be signed and/or encrypted. Advantageously, the use of digital signatures and other cryptographic techniques for protecting the manifest files and/or diffs enable the ZTM to validate that the CDN has distributed update diffs and/or manifest files to individual devices without modification or third-party tampering. Consequently, these types of encryption techniques allow the ZTM to provide and apply updates to the OS and/or application stack of individual devices or groups of devices via untrusted CDN's or other public network or cloud-based environments.

3.0 Operational Summary of the ZTM:

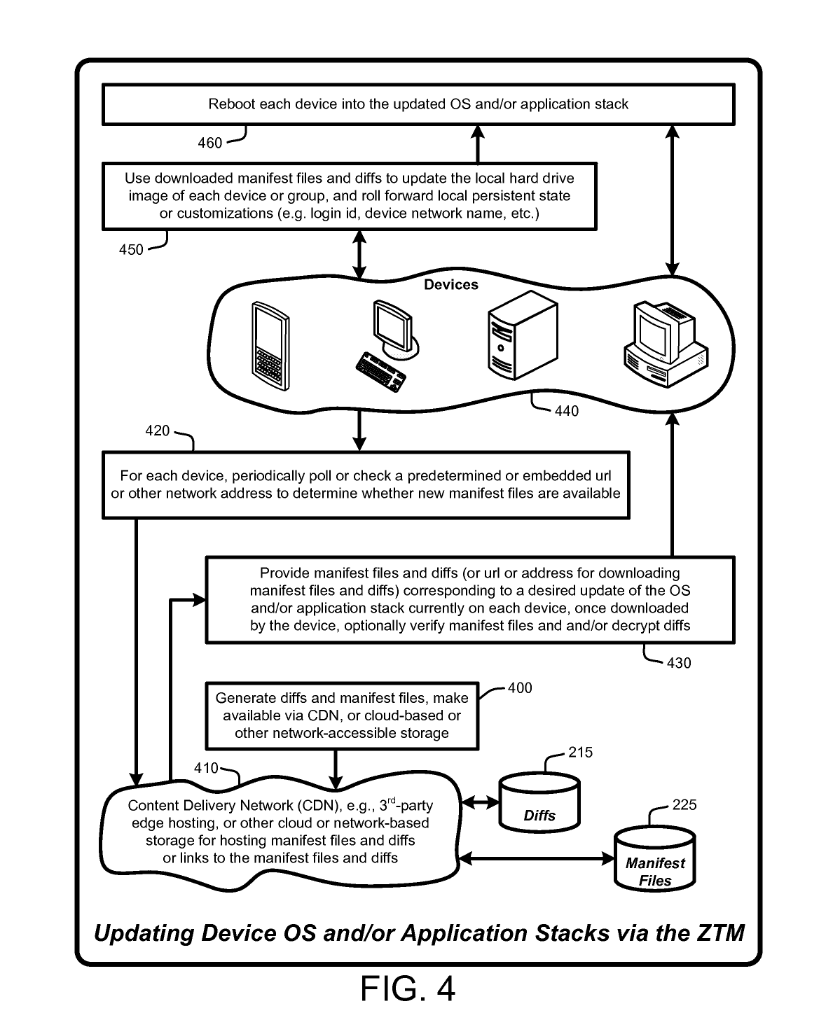

Various processes described above with respect to FIG. 1 through FIG. 3, and in further view of the detailed description provided above in Sections 1 and 2 are illustrated by the general operational flow diagram of FIG. 4. In particular, FIG. 4 provides an exemplary operational flow diagram that summarizes the operation of one or more embodiments of the ZTM for updating device OS and/or application stacks using manifest files and diffs. Note that FIG. 4 is not intended to be an exhaustive representation of all of the various embodiments of the ZTM described herein, and that the embodiments represented in FIG. 4 are provided only for purposes of explanation. Further, it should be noted that FIG. 4 represents one or more embodiments of the ZTM that may be used in combination with other embodiments of the ZTM that are described throughout this document.

In general, as illustrated by FIG. 4, the ZTM first generates 400 diffs 215 and manifest files 225, and then makes these diffs and manifest available via CDN 410 or cloud-based or other network-accessible storage. The CDN 410 or cloud-based or other network accessible storage simply hosts the diffs 215 and manifest files 225, or provides links to the manifest files and diffs for download by devices 440.

Each device 440 or each group of devices, periodically polls 420 or contacts the CDN 410 or cloud-based or other network accessible storage or predetermined or embedded url or other network address to determine whether new manifest files are available for download. Manifest files and diffs (or url or address for downloading manifest files and diffs) corresponding to a desired update of the OS and/or application stack currently on each device 440 are then provided 430 to the devices. Once downloaded by the device, each device optionally verifies a digital signature of the manifest files and/or decrypts the diff.

Each device 440 then locally uses 450 the downloaded manifest files 225 and diffs 215 to update its local hard drive image. Each updated device 410 also rolls forward is persistent state or local customizations (e.g., login ID, device network name, etc.) as discussed in detail above in Section 2.5.2. Finally, each device 440 is simply rebooted 460 following the update process, with a single reboot being sufficient to boot each device into the updated OS and/or application stack.

4.0 Exemplary Operating Environments:

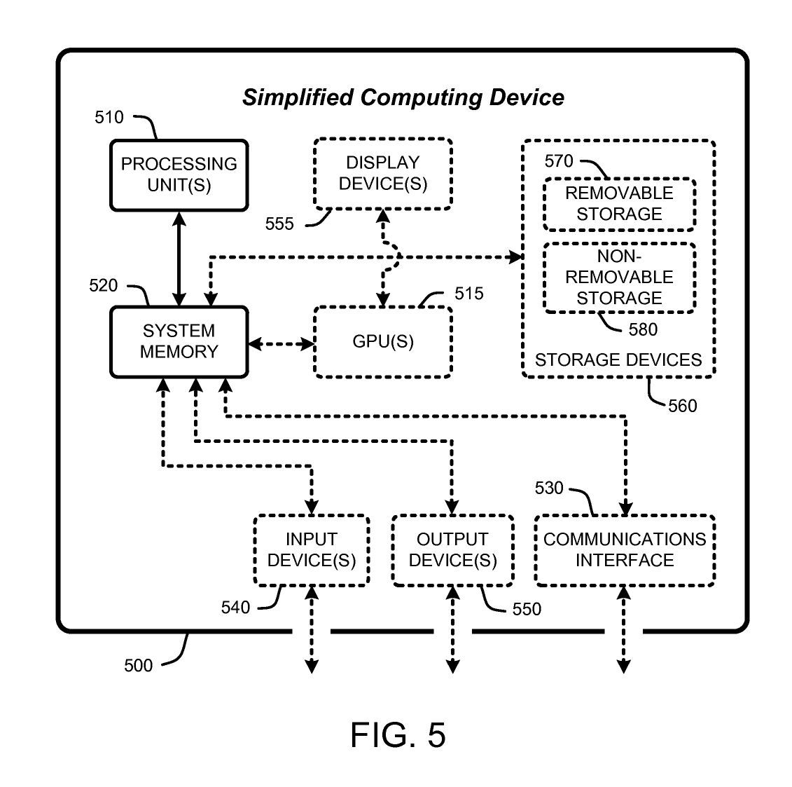

The ZTM described herein is operational within numerous types of general purpose or special purpose computing system environments or configurations. FIG. 5 illustrates a simplified example of a general-purpose computer system on which various embodiments and elements of the ZTM, as described herein, may be implemented. It should be noted that any boxes that are represented by broken or dashed lines in FIG. 5 represent alternate embodiments of the simplified computing device, and that any or all of these alternate embodiments, as described below, may be used in combination with other alternate embodiments that are described throughout this document.

For example, FIG. 5 shows a general system diagram showing a simplified computing device such as computer 500. Such computing devices can be typically be found in devices having at least some minimum computational capability, including, but not limited to, robotic devices, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the ZTM, the device should have a sufficient computational capability and system memory to enable basic computational operations. In particular, as illustrated by FIG. 5, the computational capability is generally illustrated by one or more processing unit(s) 510, and may also include one or more GPUs 515, either or both in communication with system memory 520. Note that that the processing unit(s) 510 of the general computing device of may be specialized microprocessors, such as a DSP, a VLIW, or other micro-controller, or can be conventional CPUs having one or more processing cores, including specialized GPU-based cores in a multi-core CPU.

In addition, the simplified computing device of FIG. 5 may also include other components, such as, for example, a communications interface 530. The simplified computing device of FIG. 5 may also include one or more conventional computer input devices 540 (e.g., pointing devices, keyboards, audio input devices, video input devices, haptic input devices, devices for receiving wired or wireless data transmissions, etc.). The simplified computing device of FIG. 5 may also include other optional components, such as, for example, one or more conventional computer output devices 550 (e.g., display device(s) 555, audio output devices, video output devices, devices for transmitting wired or wireless data transmissions, etc.). Note that typical communications interfaces 530, input devices 540, output devices 550, and storage devices 560 for general-purpose computers are well known to those skilled in the art, and will not be described in detail herein.

The simplified computing device of FIG. 5 may also include a variety of computer readable media. Computer readable media can be any available media that can be accessed by computer 500 via storage devices 560 and includes both volatile and nonvolatile media that is either removable 570 and/or non-removable 580, for storage of information such as computer-readable or computer-executable instructions, data structures, program modules, or other data. By way of example, and not limitation, computer readable media may comprise computer storage media and communication media. Computer storage media includes, but is not limited to, computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of the any of the above should also be included within the scope of communication media.

Further, software, programs, and/or computer program products embodying the some or all of the various embodiments of the ZTM described herein, or portions thereof, may be stored, received, transmitted, or read from any desired combination of computer or machine readable media or storage devices and communication media in the form of computer executable instructions or other data structures.

Finally, the ZTM described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

The foregoing description of the ZTM has been presented for the purposes of illustration and description. It is not intended to be exhaustive or to limit the claimed subject matter to the precise form disclosed. Many modifications and variations are possible in light of the above teaching. Further, it should be noted that any or all of the aforementioned alternate embodiments may be used in any combination desired to form additional hybrid embodiments of the ZTM. It is intended that the scope of the invention be limited not by this detailed description, but rather by the claims appended hereto.

What is claimed is:

1. A computer-implemented process for updating devices, comprising using a computer to perform process actions for:
generating a virtual hard drive (VHD) image for each of one or more versions of a system image for one or more devices;
designating one of the VHD images as an update VHD image and the remaining VHD images as reference system images;
creating one or more diffs by differencing the update VHD image relative to one or more of the reference system images, each diff comprising sectors of the update VHD image that have changed relative to the corresponding reference system image;
providing one of the diffs to one or more of the devices, each such diff having been created using one of the reference system images corresponding to a current system image of the device receiving the diff; and
modifying the version of the system image of one or more of the devices by using the sectors in the diff received by each device to replace each corresponding sector of the system image of that device.

2. The computer-implemented process of claim 1 wherein each VHD is created by installing a corresponding system version onto a reference copy of a particular hardware version each device.

3. The computer-implemented process of claim 2 wherein one or more groups of multiple devices having the same hardware version are updated to the same version of system image by providing each device in the group with a diff that corresponds to the version of the system image of each device.

4. The computer-implemented process of claim 1 wherein one or more of the diffs include information for updating device firmware version.

5. The computer-implemented process of claim 1 further comprising process actions for rolling forward local device customization information into the modified version of the system image of one or more of the devices.

6. The computer-implemented process of claim 1 further comprising process actions for rebooting each device having a modified version of the system image to boot into a version of the system image that is the same as the update VHD.

7. The computer-implemented process of claim 1 wherein the diff provided to any particular device is selected from the available diffs in response to version information comprising a current device hardware version and a current system image version reported by that device.

8. The computer-implemented process of claim 7 further comprising process actions for providing a manifest file tailored to the reported version information with each diff, each manifest file specifying the sectors of the corresponding diff to be used for modifying the system image of the device.

9. The computer-implemented process of claim 8 wherein the manifest files and diffs are encrypted using private/public key cryptographic techniques.

10. The computer-implemented process of claim 9 wherein the encrypted manifest files and diffs are provided to devices via one or more public content delivery networks.

11. A computer-readable medium having computer executable instructions stored therein for updating device system images, said instructions causing a computing device to execute a method comprising:
for one or more groups of one or more devices, periodically reporting version information comprising a device hardware version and a system image version;
for one or more of the groups that report version information, evaluating that information to determine whether any update is available to any of those groups;
for one or more of the groups for which an update is available, providing an update diff to one or more devices in the group, each diff containing portions of the system image of each device that have changed relative to a new version of the system image corresponding to the available update; and
for one or more devices receiving a diff, updating the system image of the device by using portions from the diff to replace each portion of the system image of the device that has changed relative to the new version of the system image.

12. The computer-readable medium of claim 11, wherein each portion in the diff represents a drive sector, and wherein each diff is constructed from sectors identified by performing a sector-level differencing between the new version of the system image and a reference copy of the system image version of each device.

13. The computer-readable medium of claim 11 further comprising instructions for rolling forward local device customization information into the updated system image when updating the system image of the device.

14. The computer-readable medium of claim 11 further comprising instructions for rebooting each device having an updated system image to boot into the new version of the system image.

15. The computer-readable medium of claim 11 further comprising instructions for providing a manifest file with each diff that specifies the portions of each diff to be used for updating the system image of the device based on the reported version information.

16. The computer-readable medium of claim 15 wherein the manifest files and diffs are encrypted using private/public key cryptographic techniques.

17. The computer-readable medium of claim 16 wherein the encrypted manifest files and diffs are provided to devices via one or more public content delivery networks.

18. A system for updating system versions of devices, comprising:
a device for generating a virtual hard drive (VHD) image for each of one or more versions of a system image for one or more devices;
wherein each VHD is created by installing a corresponding system version onto a reference copy of a particular hardware version each device;
a device for designating one of the VHD images as an update VHD image and the remaining VHD images as reference system images;
a device for creating one or more diffs by differencing the update VHD image relative to one or more of the reference system images, each diff comprising sectors of the update VHD image that have changed relative to the corresponding reference system image;
a device for providing one of the diffs to one or more of the devices, each such diff having been created using one of the reference system images corresponding to a current system image of the device receiving the diff;
wherein the diff provided to any particular device is selected from the available diffs in response to version information comprising a current device hardware version and a current system image version reported by that device; and
a device for modifying the version of the system image of one or more of the devices by using the sectors in the diff received by each device to replace each corresponding sector of the system image of that device.

19. The system of claim 18 wherein each device in one or more groups of multiple devices having the same hardware version are updated to the same version of system image using the diff provided to each device.

20. The system of claim 19 further comprising:
a device for generating a manifest file tailored to the reported version information with each diff, each manifest file specifying the sectors of the corresponding diff to be used for modifying the system image of the device;
wherein the manifest files and diffs are encrypted using private/public key cryptographic techniques; and
wherein the encrypted manifest files and diffs are provided to devices via one or more public content delivery networks.
